(19) United States
(12) Patent Application Publication
(10) Pub. No.: US 2013/0173139 A1
(43) Pub. Date: Jul. 4, 2013

(54) CONTROL DEVICE FOR INTERNAL COMBUSTION ENGINE

(71) Applicant: Shunichi Yoshikawa, Ebina-shi (JP)

(72) Inventor: Shunichi Yoshikawa, Ebina-shi (JP)

(73) Assignee: NISSAN MOTOR CO., LTD.

(21) Appl. No.: 13/820,723

(22) PCT Filed: Dec. 27, 2011
(86) PCT No.: PCT/JP2011/080174

§ 371 Date: Mar. 4, 2013

(30) Foreign Application Priority Data
Dec. 27, 2010 (JP) 2010-290270

(51) Int. Cl. F02D 41/00

(52) U.S. Cl. CPC F02D 41/00
USPC 701/103

(57) ABSTRACT

A control device for an internal combustion engine includes a unit for performing precorrection of an intake air quantity immediately after engine startup on the basis of a change value in the intake air quantity immediately after the beginning of cranking, and a correction method switching unit for subsequently switching to precorrection of the intake air quantity corresponding to an accelerator pedal stroke on the basis of the intake air quantity.

### TECHNICAL FIELD

The present disclosure relates to a control device for an internal combustion engine.

### BACKGROUND ART

A control device for an internal combustion engine sets a fuel quantity to be injected on the basis of an intake air flow rate measured by an airflow meter located upstream of an intake throttle and a target air-fuel ratio.

Since there is a distance between the intake throttle and a cylinder, a time lag occurs until the air quantity introduced into the cylinder actually increases after execution of accelerating operation under transient driving conditions, such as acceleration or deceleration. For this reason, there occurs a difference between a intake air quantity calculated on the basis of the airflow meter and an actual intake air quantity so that a mixture in the cylinder will temporarily deviate from the target air-fuel ratio.

Under such circumstances, JP01-305144A published by the Japan Patent Office in 1989 predicts the air quantity in a cylinder at a timing when an intake valve is closed using the degree of change (gradient) in the intake air quantity at a timing of calculating the fuel quantity to be injected. Also, in JP4321429B, the air quantity in the cylinder at the timing when the intake valve is closed that varies with a time delay is predicted from the amount of control of a throttle valve at the timing of calculating the fuel quantity to be injected. Then, the fuel quantity to be injected that corresponds to the intake air quantity in the cylinder is calculated from the intake air quantity thus obtained and a stoichiometric air-fuel ratio, and the fuel of which quantity has been thus determined by calculation is injected.

### SUMMARY

In each of the aforementioned methods, a so-called precorrection is performed by predicting a air quantity confined in the cylinder before the air is actually introduced into the cylinder. It is therefore possible to inject the fuel of which quantity is based on the result of calculation prior to a timing at which the intake valve is closed.

Precorrection performed on the basis of the amount of control of the throttle valve gives a higher accuracy of prediction of the intake air quantity than precorrection performed on the basis of the degree of change (gradient) in the current intake air quantity under most conditions. Recently, however, control operation which makes it possible to manipulate the throttle valve even during a cranking process is under study. Specifically, this approach is to close the throttle valve during the cranking process and open the throttle valve subsequently. If the throttle valve is so controlled, a negative pressure develops during the cranking process, thereby accelerating evaporation of the fuel. Also, a sufficient air quantity is obtained at a time when an explosion stroke is completed. If the throttle valve is made manipulatable during the cranking process as mentioned above, however, air in a collector that is at atmospheric pressure flows into the engine even when the throttle valve is closed in an initial stage of the cranking process. As a consequence, a relationship between a throttle valve opening and the air quantity in the cylinder is jeopardized. Thus, it has been newly recognized that the precorrection based on the amount of control of the throttle valve produces a poorer accuracy than the precorrection based on the degree of change (gradient) in the current intake air quantity.

The present disclosure has been made in light of the aforementioned conventional problems. Accordingly, it is an object of the disclosure to provide a control device for an internal combustion engine which makes it possible to precorrect the intake air quantity with high accuracy even during a cranking process.

A control device for an internal combustion engine in one embodiment of the present invention includes a unit for performing precorrection of an intake air quantity immediately after engine startup on the basis of a change value in the intake air quantity in a cylinder immediately after the beginning of cranking, and a correction method switching unit for subsequently switching to precorrection of the intake air quantity corresponding to an accelerator pedal operation amount on the basis of the intake air quantity.

An embodiment and advantages of the present invention will be described in detail hereinbelow in conjunction with the accompanying drawings.

### BRIEF DESCRIPTION OF DRAWINGS

FIG. 1 is a diagram for explaining precorrection of a intake air quantity based on an accelerator pedal operation amount that is performed during acceleration of an internal combustion engine.

FIG. 2 is a timing chart representing a case in which the precorrection of the intake air quantity based on the accelerator pedal operation amount is performed during acceleration of the internal combustion engine.

FIG. 3 is a diagram depicting a configuration for explaining an embodiment of a control device for an internal combustion engine according to the invention.

FIG. 4 is a flowchart depicting the content of specific control operation performed by the engine controller.

FIG. 5 is a diagram for explaining a basic concept of precorrection based on the change value Δ in a cylinder intake air quantity.

FIG. 6 is a flowchart depicting the specific content of the precorrection based on the change value Δ in the cylinder intake air quantity.

FIG. 7 is a diagram for explaining operational effects of the embodiment.

### EMBODIMENT

To facilitate understanding of the present invention, precorrection of a intake air quantity based on an accelerator pedal operation amount is described at first. Meanwhile, a discussion that follows hereunder is confined to a simple description of the precorrection as a detailed description is provided in JP4321429B.

It is impossible to estimate the intake air quantity in advance of an injection timing depending on operating conditions of an internal combustion engine even if a fuel quantity to be injected is set on the basis of a flow rate detected by an airflow meter as mentioned in the foregoing. The result is that the fuel injection quantity is set by adopting a value estimated in a preceding cycle. Should this situation occur, the accuracy of estimating the intake air quantity will be so poor that there is a possibility that a mixture in a cylinder will temporarily deviate from a target air-fuel ratio.

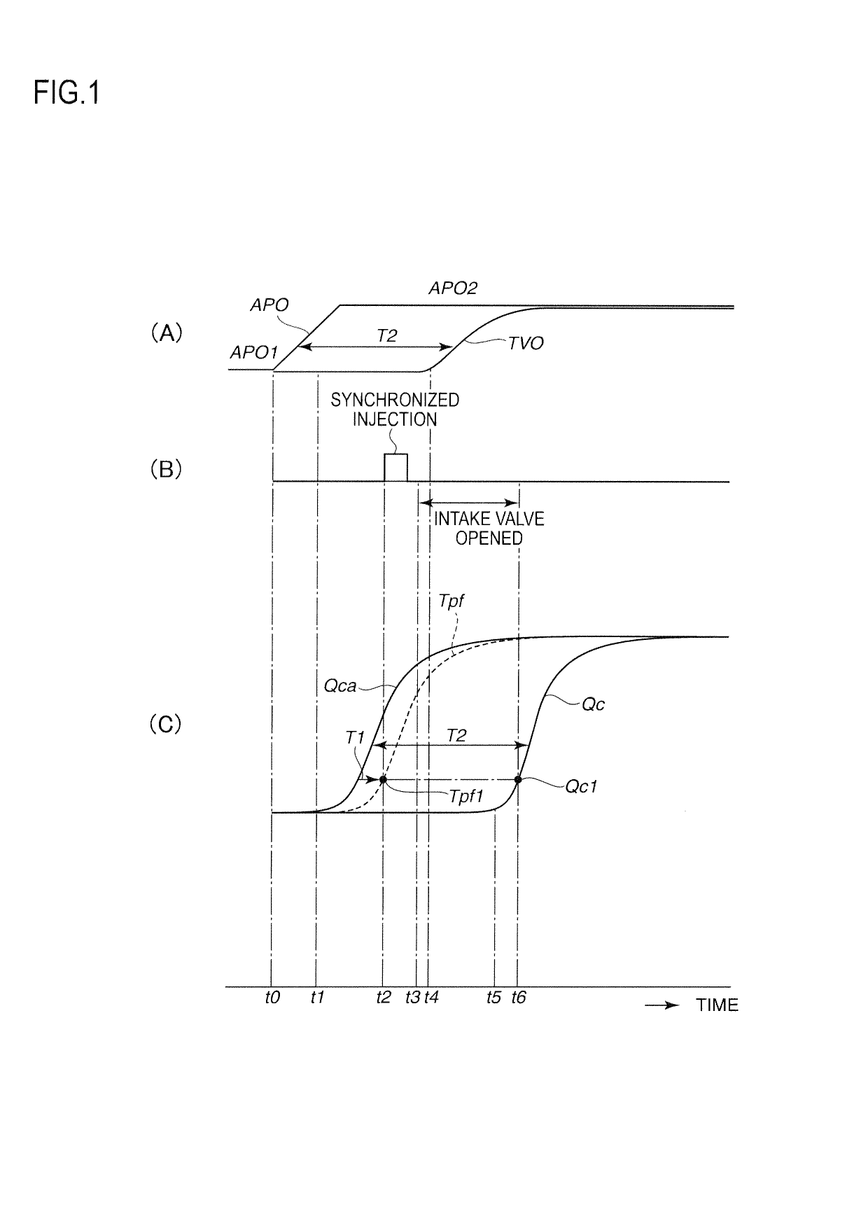

Under such circumstances, the applicant completed a patent in which the fuel injection quantity is set by estimating the intake air quantity on the basis of an accelerator pedal operation amount (JP4321429B). This approach is described below with reference to FIG. 1.

FIG. 1 is a diagram for explaining precorrection of a intake air quantity based on an accelerator pedal operation amount that is performed during acceleration of an internal combustion engine.

Referring to FIG. 1(A), as a driver depresses the accelerator pedal, the accelerator pedal operation amount (APO) begins to increase from first operation amount APO1 to second operation amount APO2 at time t1. Throttle valve opening (TVO) of an intake throttle varies with a time lag from a change in the accelerator pedal operation amount (APO) as mentioned earlier. Here, the throttle valve opening TVO begins to increase at time t4. When the throttle valve opening TVO increases, the flow rate of intake air passing through an intake passage increases. The air thus taken in is once stored in a collector and then introduced into a cylinder from an intake manifold. Therefore, the air quantity introduced into the cylinder begins to increase at time t5 which is further delayed. The air quantity introduced into the cylinder is referred to as the cylinder intake air quantity Qc.

The precorrection of the intake air quantity based on the accelerator pedal operation amount is intended to increase the accuracy of controlling an air-fuel ratio by making up for a deviation of changes in the intake air quantity and the fuel injection quantity from each other under transient driving conditions including acceleration. Thus, for the convenience of explanation, the cylinder intake air quantity Qc and required fuel injection quantity Tpf are drawn at the same height in FIG. 1(C). In actuality, however, the intake air quantity is 14.7 when the fuel injection quantity is 1 at the stoichiometric air-fuel ratio. Also, the cylinder intake air quantity Qc is expressed in terms of grams/cycle while the required fuel injection quantity Tpf is expressed in terms of milliseconds. These variables are expressed by using different units in this way. Since what is important herein is simply the timing of increase of each variable, the difference in the units is ignored for the sake of simplification of notation. Consequently, the cylinder intake air quantity Qc and the required fuel injection quantity Tpf are represented by waveforms having the same shape. The two waveforms are simply displaced along the direction of a time axis.

Response delay period T2 from time t0 at which the accelerator pedal operation amount APO begins to increase to time t4 at which the throttle valve opening TVO begins to increase is practically about 40 to 50 milliseconds. This response delay period T2 is referred to as idle period T2 in the following discussion.

In the precorrection of the intake air quantity based on the accelerator pedal operation amount, the fuel injection quantity is calculated on the basis of the accelerator pedal operation amount APO, and not the throttle valve opening TVO. As a result, the required fuel injection quantity Tpf is calculated in advance of a change in the throttle valve opening TVO.

Therefore, an engine controller calculates cylinder intake air quantity Qca corresponding to the accelerator pedal operation amount advanced by as much as the idle period T2 from the cylinder intake air quantity Qc on the basis of the accelerator pedal operation amount APO. The idle period T2 is predefined as a fixed value. The engine controller further obtains the required fuel injection quantity Tpf by applying a delay of idle period T1 to the cylinder intake air quantity Qca corresponding to the accelerator pedal operation amount so that the cylinder intake air quantity Qca is synchronized with the injection timing. Meanwhile, the required fuel injection quantity Tpf is represented by a broken line in FIG. 1(C).

In the meantime, individual curves in FIG. 1(C) are calculated from changes in the accelerator pedal operation amount APO. Opening/closing actions of an intake valve are not taken into account in the individual curves of FIG. 1(C). Since the intake valve closes at time t6 as depicted in FIG. 1(B) in actuality, cylinder intake air quantity Qc1 at time t6 indicates a true air quantity introduced into the cylinder. Required fuel injection quantity Tpf1 at time t2 indicates a required fuel injection quantity corresponding to the true air quantity introduced into the cylinder. Therefore, what is actually calculated by the engine controller is the value Tpf1 at time t2.

In FIGS. 1(A) to 1(C), speed Ne of the internal combustion engine is set at a fixed value N0 and an assumption is made that the injection timing is at time t2 which is slightly delayed from time t0. A period from time t3 to time t6 is an opening period of the intake valve. The injection timing is set at a point immediately preceding an intake stroke. This relationship equally applies to any of cylinders.

As a horizontal axis of FIGS. 1(A) to 1(C) represents the time axis, the injection timing varies when the engine speed Ne alters. Specifically, if the engine speed Ne becomes smaller than the fixed value N0, the injection timing is retarded to a point later than timing t2 and thus shifted rightward as illustrated. If the engine speed Ne becomes larger than the fixed value N0, the injection timing is advanced to a point earlier than the timing t2 and thus shifted leftward as illustrated. Thus, the idle period T1 also varies as a consequence. This means that the idle period T1 is a function of the engine speed Ne.

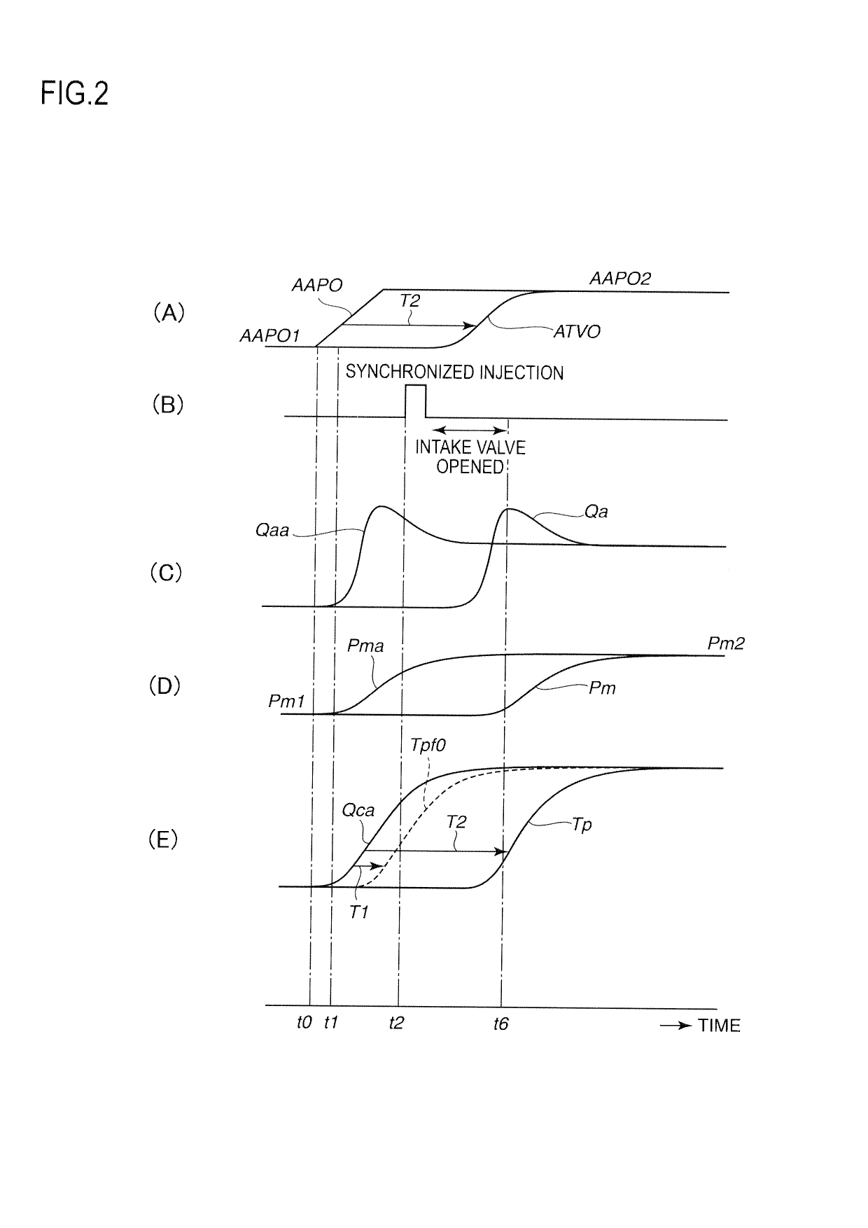

FIG. 2 is a timing chart representing a case in which the precorrection of the intake air quantity based on the accelerator pedal operation amount is performed during acceleration of the internal combustion engine.

Referring to FIG. 2(A), designated by ATVO is a throttle valve-opening area determined by the throttle valve opening TVO of the intake throttle, and designated by AAPO is an “accelerator area” which is imaginarily obtained from the accelerator pedal operation amount APO. The accelerator area AAPO is in one-to-one correspondence with the throttle valve-opening area ATVO. This means that a maximum value of the accelerator area AAPO equals that of the throttle valve-opening area ATVO. Therefore, the accelerator area obtained when the accelerator pedal is fully depressed equals the throttle valve-opening area obtained when the intake throttle is fully opened (full throttle). Also, the accelerator area obtained when the accelerator pedal is depressed to a halfway point equals the throttle valve-opening area obtained when the intake throttle is opened to a halfway point.

It should be noted however that a leading edge of the throttle valve opening TVO is delayed from a leading edge of the accelerator pedal operation amount APO by as much as a response delay period of the intake throttle during the transient driving conditions as depicted in FIG. 1(A). Likewise, a leading edge of the throttle valve-opening area ATVO is delayed from a leading edge of the accelerator area AAPO by as much as the response delay period of the intake throttle as depicted in FIG. 2(A). The response delay period of the throttle valve-opening area ATVO from the accelerator area AAPO is equal to the response delay period (idle period) T2.

Referring to FIG. 2(C), designated by Qa is a flow rate (airflow meter-based flow rate) detected by the airflow meter, and designated by Qaa is a preliminary flow rate of the airflow meter-based flow rate and is referred to as an accelerator pedal operation amount-corresponding flow rate.

Referring also to FIG. 2(D), designated by Pa is atmospheric pressure (manifold pressure) detected by a pressure sensor, and designated by Pma is a preliminary pressure of the manifold pressure and is referred to as an accelerator pedal operation amount-corresponding manifold pressure.

In the precorrection of the intake air quantity based on the accelerator pedal operation amount, the accelerator pedal operation amount-corresponding flow rate Qaa is calculated before the airflow meter-based flow rate Qa is calculated. The accelerator pedal operation amount-corresponding flow rate Qaa makes it possible to predict a profile of the airflow meter-based flow rate Qa with high accuracy. Since the cylinder air quantity Qc is determined at intake valve close timing IVC, it is necessary to give a fuel injection quantity corresponding to the cylinder air quantity thus determined at a synchronized injection timing in order to achieve the stoichiometric air-fuel ratio (target air-fuel ratio). According to the precorrection of the intake air quantity based on the accelerator pedal operation amount, it is possible to predict the profile of the airflow meter-based flow rate Qa with high accuracy. Therefore, it is possible to calculate a fuel injection quantity which is neither excessive nor insufficient for achieving the target air-fuel ratio corresponding to the cylinder air quantity determined at injector close timing IVC. It is then possible to inject fuel at the synchronized injection timing without a delay in response. This results in an improvement in the accuracy of controlling the air-fuel ratio under transient driving conditions.

Incidentally, the opening of the intake throttle is not adjusted during a cranking process in conventional practice. The inventor and colleagues, however, are studying a technique which makes it possible to obtain a sufficient air quantity at a time when an explosion stroke is completed while developing a negative pressure on a downstream side along an intake air flow direction of the intake throttle and thereby accelerating evaporation of the fuel by properly regulating the opening of the intake throttle during the cranking process.

It has however been recognized that, in such a technique, the intake air quantity can not be estimated with high accuracy by performing preestimation of the intake air quantity based on the accelerator pedal operation amount. Specifically, in an initial stage of the cranking process, the opening of the intake throttle is properly closed although the accelerator pedal is not operated. Under such conditions, air in the intake air collector that is at atmospheric pressure chiefly flows into the engine. Thus, a correlation between the accelerator pedal operation amount and the intake air quantity is jeopardized. Therefore, it is impossible to estimate the intake air quantity with high accuracy.

Accordingly, an approach that is employed in such a case is to make a precorrection of the intake air quantity at the intake valve close timing by using a rate of change in the intake air quantity.

The specific content of this approach is described hereinbelow.

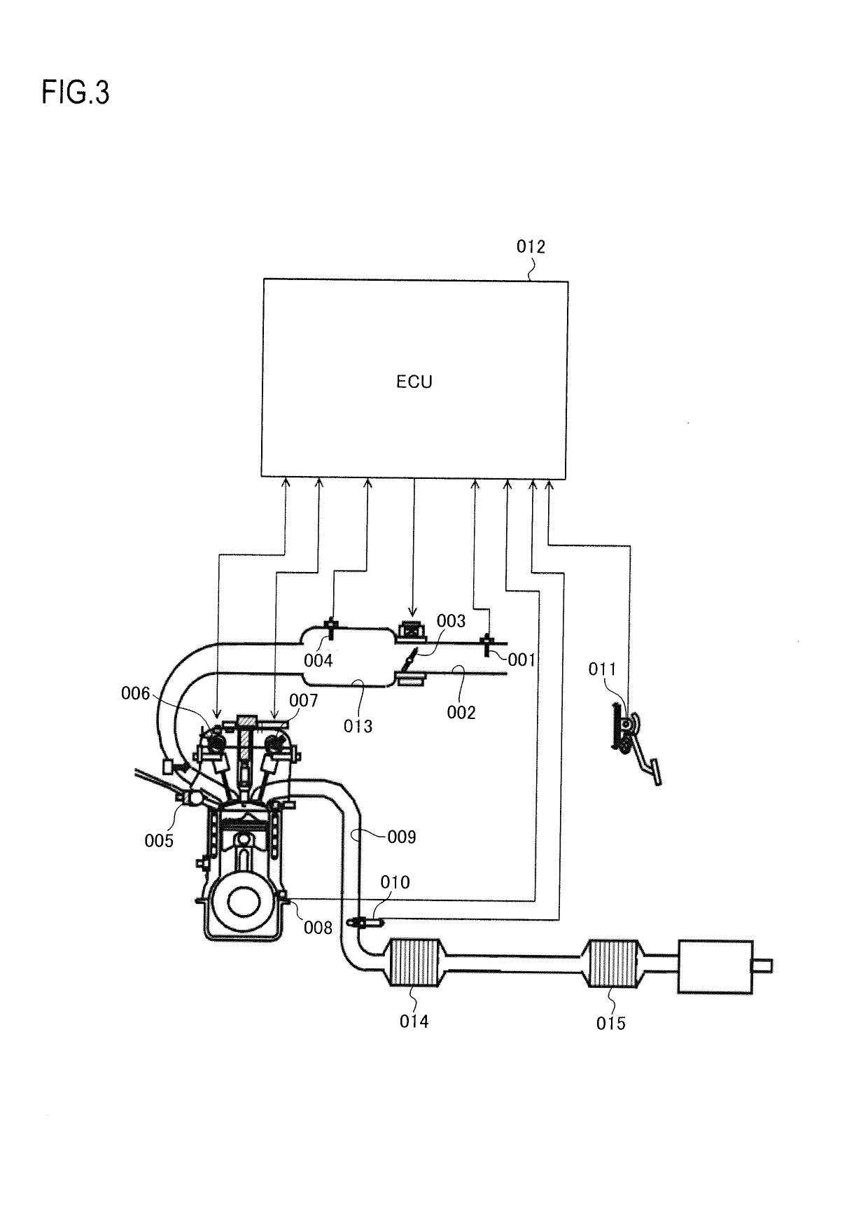

FIG. 3 is a diagram depicting a configuration for explaining an embodiment of a control device for an internal combustion engine according to the invention.

The internal combustion engine control device of this embodiment calculates the flow rate of intake air taken into an internal combustion engine body 100 with high accuracy. In an intake passage 002 of the internal combustion engine body 100, there are provided an airflow meter 001, an intake throttle 003, an intake air pressure sensor 004 and an injector 005 in this order from an upstream side along a flow direction of air.

The airflow meter 001 is a hot-wire airflow meter. When air flows along a wire (hot wire) which is heated when conducting an electric current, the wire is deprived of heat. The higher the speed of airflow (i.e., the larger the intake air quantity introduced per unit time), the more the wire is deprived of heat. This results in a change in the resistance of the wire. The hot-wire airflow meter is a device which detects the intake air flow rate by using such property.

The intake throttle 003 of which opening is adjusted in accordance with a target output regulates the flow rate of intake air introduced into the internal combustion engine body 100. Although the target output is normally set in accordance with a signal representative of an accelerator pedal operation amount detected by an acceleration sensor 011, the target output is set independently of the sensing signal of the acceleration sensor 011 during operation by automatic cruise control, for example.

The intake air pressure sensor 004 which is provided in an intake air collector 013 detects the pressure of the intake air that flows along through the intake air collector 013. The intake air collector 013 is provided downstream of the intake throttle 003. Therefore, the pressure detected by the intake air pressure sensor 004 is equal to or lower than atmospheric pressure.

The injector 005 injects fuel. The injector 005 may be of a type which injects the fuel into an intake port or of a type which injects the fuel directly into a cylinder of the internal combustion engine body 100.

The internal combustion engine body 100 is provided with an intake valve train 006, an exhaust valve train 007 and a crank angle sensor 008.

The intake valve train 006 opens and closes the cylinder and the intake port of the internal combustion engine body 100 by means of an intake valve. The intake valve train 006 may be of a type which opens and closes the intake valve at fixed crank angles (opening/closing timings) or of a type which opens and closes the intake valve at crank angles (opening/closing timings) that are variable in accordance with operating conditions. In a case where the intake valve train 006 is of a type capable of altering the valve opening/closing timings, the intake valve train 006 is furnished with a sensor for detecting actual valve opening/closing timings as well as an actuator for altering the valve opening/closing timings. A sensing signal of this sensor is sent to an engine controller 012. Also, the actuator alters the valve opening/closing timings on the basis of a signal received from the engine controller 012.

The exhaust valve train 007 opens and closes the cylinder and an exhaust port of the internal combustion engine body 100 by means of an exhaust valve. The exhaust valve train 007 may be of a type which opens and closes the exhaust valve at fixed crank angles (opening/closing timings) or of a type which opens and closes the exhaust valve at crank angles (opening/closing timings) that are variable in accordance with the operating conditions. In a case where the exhaust valve train 007 is of a type capable of altering the valve opening/closing timings, the exhaust valve train 007 is furnished with a sensor for detecting actual valve opening/closing timings as well as an actuator for altering the valve opening/closing timings. A sensing signal of this sensor is sent to the engine controller 012. Also, the actuator alters the valve opening/closing timings on the basis of a signal received from the engine controller 012

The crank angle sensor 008 detects the angle of rotation of a crankshaft.

In an exhaust passage 009 of the internal combustion engine body 100, there are provided an upstream exhaust emission control catalytic converter 014 and a downstream exhaust emission control catalytic converter 015 in this order from the upstream side along the flow direction of air. There is provided an A/F sensor (air-fuel ratio sensor) 010 close to an inlet of the upstream exhaust emission control catalytic converter 014. The A/F sensor (air-fuel ratio sensor) 010 detects the air-fuel ratio of exhaust gas expelled from the internal combustion engine body 100. The upstream exhaust emission control catalytic converter 014 and the downstream exhaust emission control catalytic converter 015 purify the exhaust gas expelled from the internal combustion engine body 100.

The engine controller 012 is made of a microcomputer including a central processing unit (CPU), a read-only memory (ROM), a random access memory (RAM) and an input/output (I/O) interface. The engine controller 012 may be configured with a plurality of microcomputers. The engine controller 012 receives signals from the airflow meter 001, the intake air pressure sensor 004, a sensor of the intake valve train 006, a sensor of the exhaust valve train 007, the crank angle sensor 008, the A/F sensor 010 and the acceleration sensor 011. The engine controller 012 then performs a prescribed mathematical operation on the basis of these signals and transmits control signals to the intake throttle 003, the injector 005, an actuator of the intake valve train 006 and an actuator of the exhaust valve train 007 to control operation of the internal combustion engine

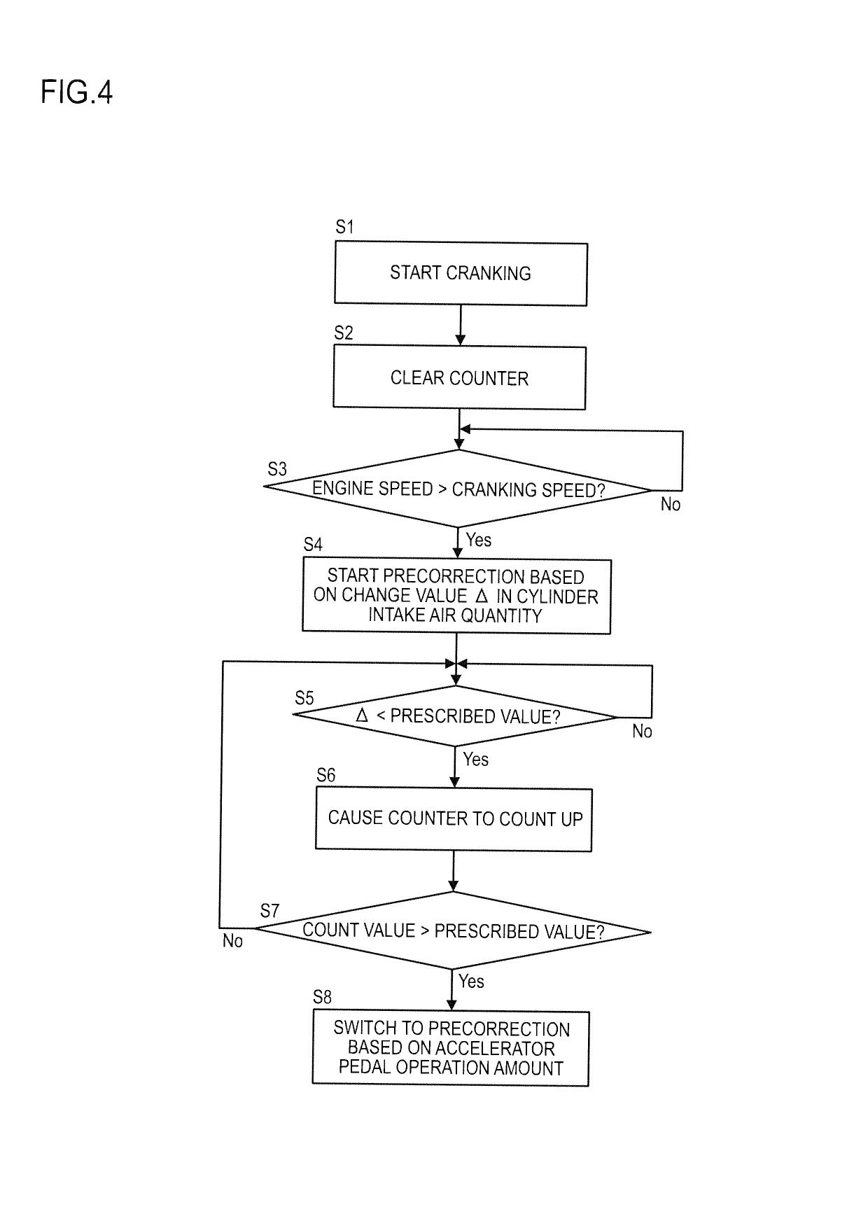

FIG. 4 is a flowchart depicting the content of specific control operation performed by the engine controller.

According to the embodiment, the engine controller initiates cranking in step S1.

In step S2, the engine controller clears a counter.

In step S3, the engine controller determines whether or not the speed of the internal combustion engine is larger than a cranking speed, whereby the engine controller determines whether or not the internal combustion engine is turning autonomously. The engine controller stays standby until the result of determination is in the affirmative and, when the result of determination is determined to be in the affirmative, the engine controller proceeds to operation in step S4.

In step S4, the engine controller initiates precorrection based on the change value Δ in the cylinder intake air quantity. The content of this step will be described later specifically.

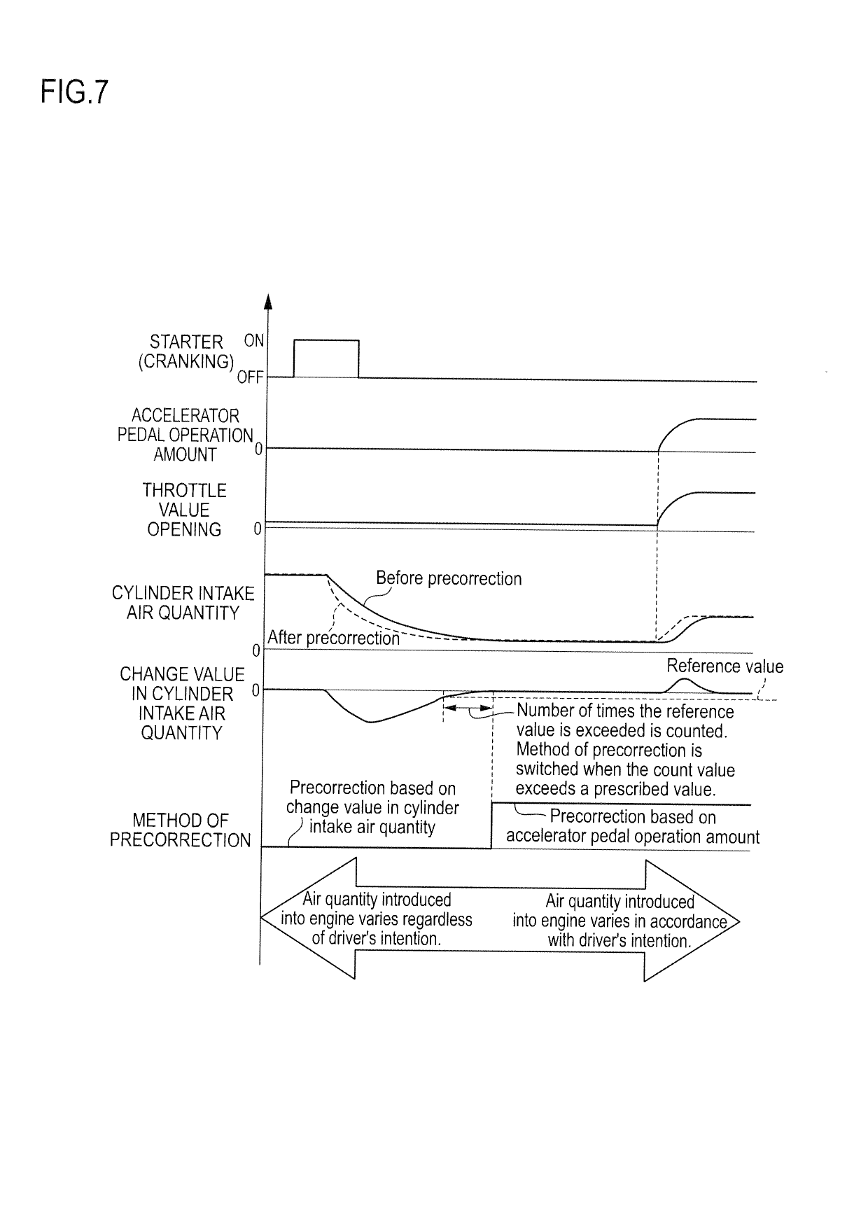

In step S5, the engine controller determines whether or not the aforementioned change value Δ has become smaller than a prescribed value (reference value). The change value Δ is obtained as the absolute value of a difference between an intake air quantity obtained at a current calculation timing and an intake air quantity obtained at a preceding calculation timing. In the meantime, FIG. 7 depicts a situation before the difference between the intake air quantities obtained at the current and preceding calculation timings is converted to an absolute value. For this reason, values are indicated as negative values and the reference value is also indicated as a negative value. The engine controller stays standby until the result of determination is in the affirmative and, when the result of determination is determined to be in the affirmative, the engine controller proceeds to operation in step S6. The aforementioned prescribed value (reference value) is an optimum value which is predetermined by an experiment in accordance with specifications of the internal combustion engine, the optimum value being suited for switching the control operation on the basis of the change value Δ in the cylinder intake air quantity. Specifically, the prescribed value (reference value) is a reference value which makes it possible to switch from precorrection based on the change value Δ in the cylinder intake air quantity to precorrection based on the accelerator pedal operation amount APO upon detecting a situation where the intake air flow rate has sufficiently increased and stabilized with high accuracy, whereby a relationship between a relationship between the throttle valve opening and the air quantity introduced into the cylinder is obtained.

In step S6, the engine controller causes the counter to count up.

In step S7, the engine controller determines whether or not the count value of the counter has become larger than a prescribed value (reference value). If the result of determination is in the negative, the engine controller proceeds to operation in step S5, whereas if the result of determination is in the affirmative, the engine controller proceeds to operation in step S8.

Incidentally, if the prescribed value (reference value) of the count value of the counter is set to an extremely small value, the engine controller instantly switches the internal combustion engine.

Also, if the prescribed value (reference value) of the count value of the counter is set to a value which is large to a certain extent, the engine controller switches the internal combustion engine when a situation where the change value Δ in the cylinder intake air quantity is larger than the prescribed value (reference value) continues to exist for a prescribed time period. In the initial stage of cranking after the beginning thereof, there exists a situation where particularly significant variations occur in the intake air flow rate. Thus, there is a possibility that the intake air flow rate may not be sufficiently stabilized even if the change value Δ in the cylinder intake air quantity once becomes smaller than the prescribed value (reference value). Nevertheless, if the prescribed value (reference value) of the count value of the counter is set to a value which is large to a certain extent, the engine controller can detect that the intake air flow rate has sufficiently increased and stabilized with high accuracy by switching the internal combustion engine when the situation where the change value Δ in the cylinder intake air quantity is larger than the prescribed value (reference value) continues to exist for the prescribed time period.

In step S8, the engine controller switches from the precorrection based on the change value Δ in the cylinder intake air quantity to the precorrection based on the accelerator pedal operation amount APO.

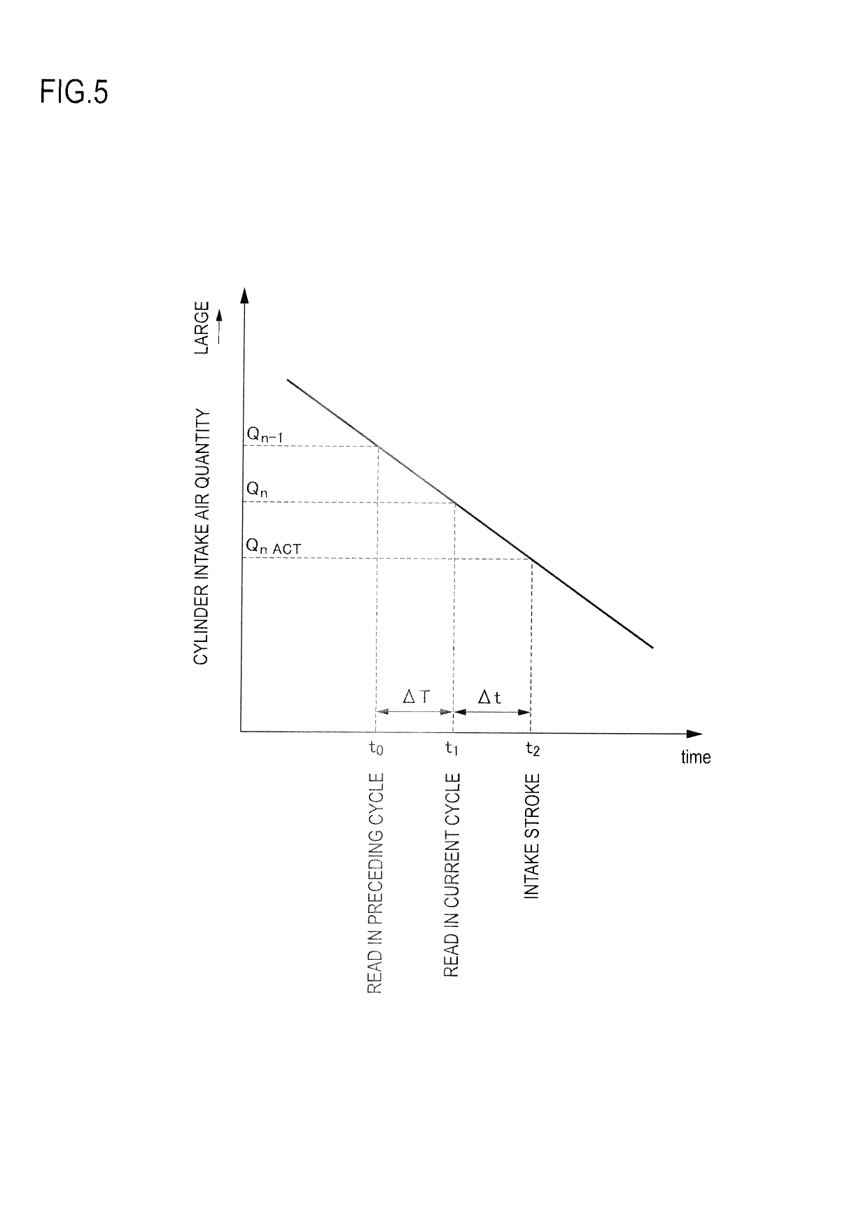

FIG. 5 is a diagram for explaining a basic concept of the precorrection based on the change value Δ in the cylinder intake air quantity.

As already mentioned, this embodiment performs the precorrection based on the change value Δ in the cylinder intake air quantity in step S4.

The basic concept of this precorrection is explained with reference to FIG. 5.

Designated by Q is the air quantity introduced into the cylinder. The subscript n designates a value read in a current cycle while the subscript n−1 designates a value read in a preceding cycle. In a case where a negative pressure is developed on the downstream side along the intake air flow direction of the intake throttle by properly regulating the opening of the intake throttle during the cranking process as mentioned earlier, the air quantity drawn out of the intake air collector 013 and introduced into the cylinder depends on the volumetric capacity of the intake air collector 013 and a pressure therein and is calculated on the basis of the engine speed. Also, the air quantity introduced into the intake air collector 013 when the pressure in the intake air collector 013 drops is detected by the airflow meter 001. The cylinder intake air quantity Q is calculated on the basis of these variables. Incidentally, the cylinder intake air quantity Q may be calculated on the basis of a signal output from the intake air pressure sensor 004 disposed in the intake air collector 013. As compared to a signal output from the airflow meter 001, the signal of the intake air pressure sensor 004 does not suddenly change. Therefore, the intake air pressure sensor 004 provides excellent accuracy immediately after engine startup.

Designated by ΔT is a time period from time t0 at which data has been read in the preceding cycle to time t1 at which data has been read in the current cycle.

Designated by Δt is a time period from time t1 at which the data has been read in the current cycle to intake stroke t2 (which is defined as a midpoint of the intake stroke for sake of simplification). Designated by QnACT is a cylinder intake air quantity estimated from Δt, ΔT, Qn−1 and Qn mentioned above.

FIG. 5 illustrates a relationship in this case. The following equation is derived from this proportional relationship:

$${Q}_{nACT} = {Q}_{n} + ( {Q}_{n} - {Q}_{n - 1} ) \times \frac{Δ t}{Δ T} \qquad ( 1 )$$

According to an engine-speed-synchronized calculation approach, ΔT is proportional to an engine turning period. Also, if time t2 is regarded as the midpoint of the intake stroke, Δt is also proportional to the engine turning period. Therefore, the above equation can be rewritten as follow:

$${Q}_{nACT} = {Q}_{n} + C \times ( {Q}_{n} - {Q}_{n - 1} ) where \\ C = \frac{Δ t}{Δ T} ( constant ) \qquad ( 2 )$$

Incidentally, according to a fixed-cycle processing method of a non-engine-speed-synchronized calculation approach, there exist relationships expressed by ΔT=constant and Δt∝(engine turning period). Also, since the engine turning period is typically always obtained by means of a counter timer for obtaining the engine speed Ne, it is possible to use the relevant data.

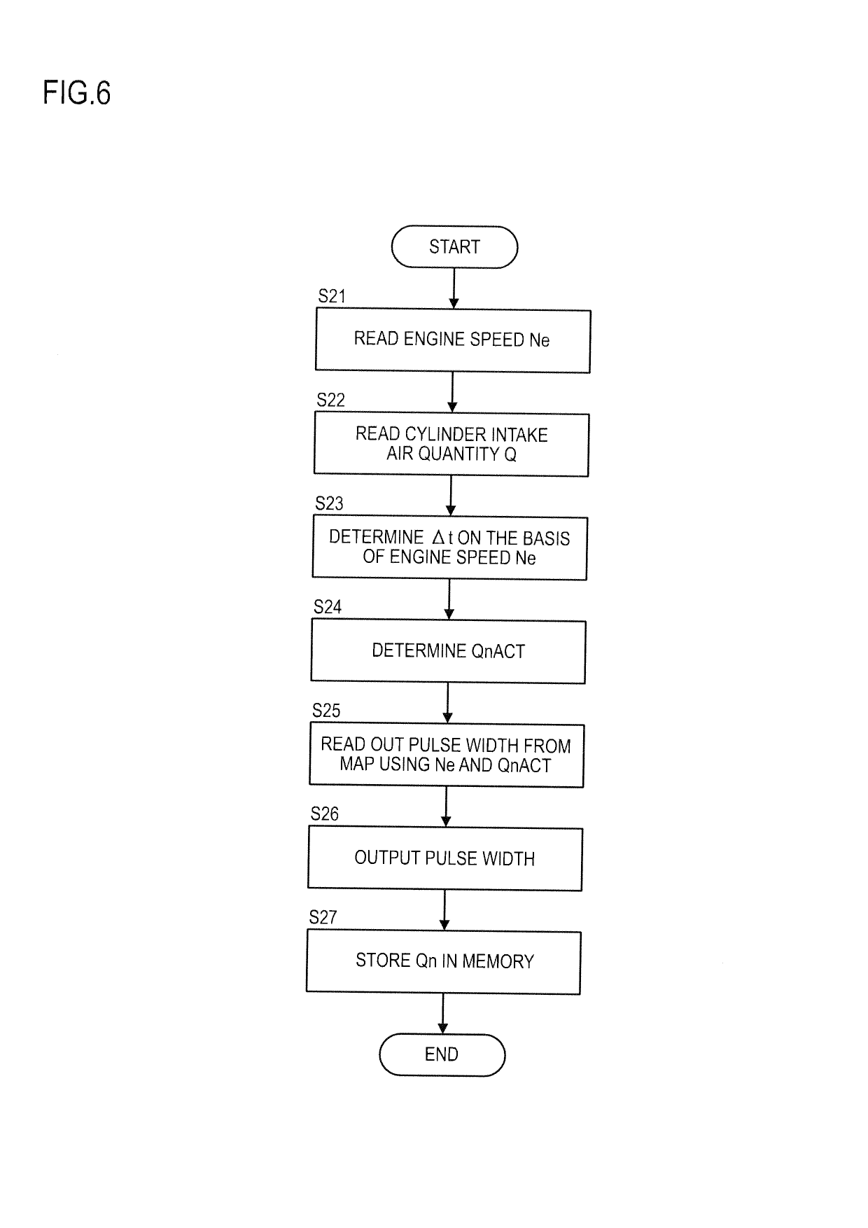

FIG. 6 is a flowchart depicting the specific content of the precorrection based on the change value Δ in the cylinder intake air quantity.

In step S21, the engine controller reads the engine speed Ne.

In step S22, the engine controller reads the cylinder intake air quantity Qn.

In step S23, the engine controller determines the time period Δt up to the intake stroke using the engine speed Ne. Meanwhile, the time period Δt determined in this step is a period of time up to the midpoint of the intake stroke. Also, the synchronized calculation approach is employed here.

In step S24, the engine controller calculates QnACT. This step S24 is an operation intended to cope with a sudden change which may occur after individual data has been read. The equation used for mathematical operation in this step is as mentioned above. The engine controller performs estimative calculation of QnACT, taking into consideration the time period Δt up to the intake stroke.

In step S25, the engine controller reads out a corrected pulse width by using QnACT and the engine speed Ne.

In step S26, the engine controller outputs the pulse width.

In step S27, the engine controller stores Qn at a present point in time. The engine controller successively updates the cylinder intake air quantity each time the engine controller reads Qn.

The aforementioned sequence of processing steps is reexecuted at regular intervals (e.g., every 3 milliseconds) with the aid of a reset timer.

In essence, the engine controller receives QnACT calculated at regular intervals and drives the injector in accordance with the pulse width at a point in time when a trigger signal is input from an engine speed sensor.

Specifically, the engine controller is configured such that when the engine speed Ne and the cylinder intake air quantity Q are varying, the engine controller determines rates of change in these variables and a time period from a point in time when information is read up until the intake stroke, estimates the cylinder intake air quantity during the intake stroke using the result of determination, and reads out a basic injection pulse width from a map using an estimated value obtained.

The above discussion has been based on the assumption that the estimated value QnACT is calculated by using the difference between a current value Qn and a previous value Qn−1 of the cylinder intake air quantity. The invention however is not limited thereto. The engine controller may be so configured as to compare the data with that obtained a specific number of cycles before and perform the aforementioned estimative calculation when a difference between the data is equal to or larger than a particular value in a case where noise associating data is unignorable. Also, the estimative calculation may be performed not only on the basis of the difference but by using a method which uses a ratio, for example. Furthermore, the estimative calculation may be applied to only one of accelerating and decelerating directions.

FIG. 7 is a diagram for explaining operational features and advantages of the embodiment.

In the initial stage of the cranking process, air in the intake air collector that is at atmospheric pressure flows into the engine. Therefore, a correlation between the opening of the intake throttle and the intake air quantity is jeopardized. Consequently, even if the intake air quantity is estimated on the basis of the opening of the intake throttle, it has been impossible to well estimate the intake air quantity.

According to the foregoing embodiment, however, the engine controller first initiates precorrection based on the change value Δ in the cylinder intake air quantity when the cranking process has started.

Then, when the change value Δ in the cylinder intake air quantity has become larger than the prescribed value (reference value), the engine controller switches to the precorrection of the intake air quantity based on the accelerator pedal operation amount.

As the above-described arrangement is employed, it is possible to estimate the intake air quantity with good accuracy as depicted in FIG. 7. Specifically, the precorrection of the intake air quantity based on the accelerator pedal operation amount involves poor preestimating accuracy in the initial stage of cranking after the beginning thereof. Thus, the precorrection based on the change value Δ in the cylinder intake air quantity is performed in this case. This approach has made possible to ensure satisfactory accuracy of preestimating the cylinder intake air quantity at the beginning of cranking.

Thus, when the change value Δ in the cylinder intake air quantity has become larger than the prescribed value (reference value), the engine controller switches to the precorrection of the intake air quantity based on the accelerator pedal operation amount. If the method of correction is switched in accordance with the change value in the above-described manner, it is possible to properly switch the method of correction with high accuracy in any case regardless of operating conditions or environmental conditions even if a different situation occurs each time cranking is performed.

While the embodiment of the present invention has thus far been described, the foregoing embodiment has portrayed simply an illustrative example of the invention and is not meant to limit the technical scope of the invention to the specific configuration described heretofore.

For example, while the method of correction is switched on the basis of the change value Δ in the cylinder intake air quantity in the foregoing discussion, the method of correction may be switched on the basis of the cylinder intake air quantity.

Incidentally, details of the foregoing embodiment may be combined as appropriate.

The present application claims priority to Japanese Patent Application No. 2010-290270 filed in Japan Patent Office on Dec. 27, 2010. The contents of this application are incorporated herein by reference in their entirety.

1. A control device for an internal combustion engine, the control device comprising:
a unit for performing precorrection of an intake air quantity immediately after engine startup on the basis of a change value in the intake air quantity immediately after the beginning of cranking; and
a correction method switching unit for subsequently switching to precorrection of the intake air quantity corresponding to an accelerator pedal stroke on the basis of the intake air quantity.

2. The control device for the internal combustion engine according to claim 1, wherein:
the correction method switching unit switches to the precorrection of the intake air quantity corresponding to the accelerator pedal stroke when the change value in the intake air quantity becomes smaller than a reference value.

3. The control device for the internal combustion engine according to claim 1, wherein:
the correction method switching unit switches to the precorrection of the intake air quantity corresponding to the accelerator pedal stroke when the intake air quantity becomes smaller than a reference value.

4. The control device for the internal combustion engine according to claim 2, wherein:
the correction method switching unit switches to the precorrection of the intake air quantity corresponding to the accelerator pedal stroke after a situation created after the change has continued to exist for a prescribed time period.

5. The control device for the internal combustion engine according to claim 1, wherein:
the intake air quantity is detected by an intake air pressure sensor provided in an intake air collector.
